(19) United States
(12) Patent Application Publication
(10) Pub. No.: US 2020/0202509 A1
(43) Pub. Date: Jun. 25, 2020

(54) INFORMATION SYSTEM AND SPECIFYING METHOD

(71) Applicant: Seiko Epson Corporation, Tokyo (JP)

(72) Inventors: Hikaru KURASAWA, Shiojiri (JP); Naoki KUWATA, Shiojiri (JP); Ryoki WATANABE, Matsumoto (JP)

(21) Appl. No.: 16/722,076

(22) Filed: Dec. 20, 2019

(30) Foreign Application Priority Data
Dec. 21, 2018 (JP) 2018-240331

(51) Int. Cl. G06T 7/00; H04N 5/33

(52) U.S. Cl. CPC G06T 7/0002; G06T 2207/30168; G06T 2207/10036; H04N 5/332

(57) ABSTRACT

An information system according to the present disclosure includes an input section to which conditions for acquiring spectral information of a target that should be measured are input, a spectral measuring section configured to acquire the spectral information of the target, a storing section in which a database including a plurality of kinds of spectral information is stored, an analysis processing section configured to specify the target by comparing the spectral information of the target and the database stored in advance, and a display section configured to display information concerning the specified target.

The present application is based on, and claims priority from, JP Application Serial Number 2018-240331, filed Dec. 21, 2018, the disclosure of which is hereby incorporated by reference herein in its entirety.

### BACKGROUND

### 1. Technical Field

The present disclosure relates to an information system and a specifying method.

### 2. Related Art

In recent years, as applications and the like included in information terminals such as a smartphone, there has been known an electronic picture book for specifying kinds of measurement targets such as animals including fish and shellfish, insects, and mammals and plants including flowers and trees based on images of the measurement targets.

For example, JP A-2008-152713 (Patent Literature 1) discloses an invention of an electronic picture book for specifying kinds of flowers set as measurement targets. In the invention disclosed in Patent Literature 1, “a color, the number, a shape of petals and a way of gathering of flowers” serving as feature values of a flower, “a shape of a leave, a shape of an edge of the leave, and hair and prickles of a stem” serving as feature values of the leave, and the like are extracted from an acquired image of the flower. A kind of the flower is specified based on these feature values, that is, the type of the flower is specified based on feature values such as a shape of the flower and a size of the shape.

However, in such an electronic picture book, when a measurement target is, for example, “similar to a pattern of a background”, “facing a direction different from a direction indicating a shape for specifying a flower”, or “protruding from an imaging region” in a captured image, it is difficult to recognize the measurement target. A kind of the measurement target cannot be specified.

Such a problem occurs because, as explained above, to specify the kind of the measurement target such as a flower, the feature values such as the shape of the measurement target and the size of the shape is used and, when the measurement target is “similar to a pattern of a background”, a “shape” cannot be segmented and, when the measurement target is “facing the front or the rear” or when the measurement target is “protruding from an imaging region”, the measurement target is different from a “shape” saved in a database included in the electronic picture book. That is, such a problem occurs because it is difficult to extract a feature value based on the shape of the measurement target necessary for specifying the kind of the measurement target.

Such a problem occurs not only in the electronic picture book for specifying kinds of animals and plants set as measurement targets in a captured image but also when presence or absence and positions of presence of animals and plants, the presence of which in a captured image is desired to be specified, are detected and when genuineness and degrees of aged deterioration of articles such as bags, wallets, watches, and jewels set as measurement targets in a captured image are judged.

### SUMMARY

The present disclosure can be realized as the following application example.

An information system according to an application example of the present disclosure includes: an input section to which conditions for acquiring spectral information of a target that should be measured are input; a spectral measuring section configured to acquire the spectral information of the target; a storing section in which a database including a plurality of kinds of spectral information is stored; an analysis processing section configured to specify the target by comparing the spectral information of the target and the database stored in advance; and a display section configured to display information concerning the specified target. According to another aspect of the present disclosure, a method that is performed by one or more processors includes accepting, via an input interface, a condition for acquiring spectral information of a target to be measured, acquiring, from a sensor, the spectral information of the target, specifying the target by comparing the spectral information of the target and a database stored in a memory, and displaying information concerning the specified target. According to still another aspect of the present disclosure, a non-transitory computer readable medium that stores instructions that cause one or more processors to perform such a method.

### BRIEF DESCRIPTION OF THE DRAWINGS

FIG. 1 is a plan view showing a front side of an overall image of a smartphone, which is an information terminal applied with a first embodiment of an information system according to the present disclosure.

FIG. 2 is a plan view showing a rear side of the overall image of the smartphone, which is the information terminal applied with the first embodiment of the information system according to the present disclosure.

FIG. 3 is an A-A line sectional view of the smartphone shown in FIG. 2.

FIG. 4 is a B-B line sectional view of the smartphone shown in FIG. 2.

FIG. 5 is a block diagram showing a schematic configuration of the smartphone shown in FIGS. 1 and 2.

FIG. 6 is a longitudinal sectional view showing an example in which a wavelength variable interference filter included in a spectral section included in a spectral measuring section of the smartphone shown in FIGS. 1 and 2 is applied to a Fabry-Perot-Etalon filter.

FIG. 7 is a flowchart showing a specifying method for specifying a kind of a measurement target with the smartphone shown in FIGS. 1 and 2.

FIG. 8 is a flowchart showing a detecting method for detecting the measurement target with the smartphone shown in FIGS. 1 and 2.

FIG. 9 is a flowchart showing a judging method for judging the measurement target with the smartphone shown in FIGS. 1 and 2.

FIG. 10 is a block diagram showing a schematic configuration of a smartphone and a spectral measuring section applied with a second embodiment of the information system according to the present disclosure.

FIG. 11 is a block diagram showing a schematic configuration of a smartphone and an external display section applied with a third embodiment of the information system according to the present disclosure.

FIG. 12 is a block diagram showing a schematic configuration of a smartphone, a spectral measuring section, and an external display section applied with a fourth embodiment of the information system according to the present disclosure.

FIG. 13 is a block diagram showing a schematic configuration of a smartphone and a server applied with a fifth embodiment of the information system according to the present disclosure.

FIG. 14 is a block diagram showing a schematic configuration of a smartphone and a server applied with a sixth embodiment of the information system according to the present disclosure.

### DESCRIPTION OF EXEMPLARY EMBODIMENTS

An information system and a specifying method according to the present disclosure are explained in detail below based on preferred embodiments shown in the accompanying drawings.

### Information System

### First Embodiment

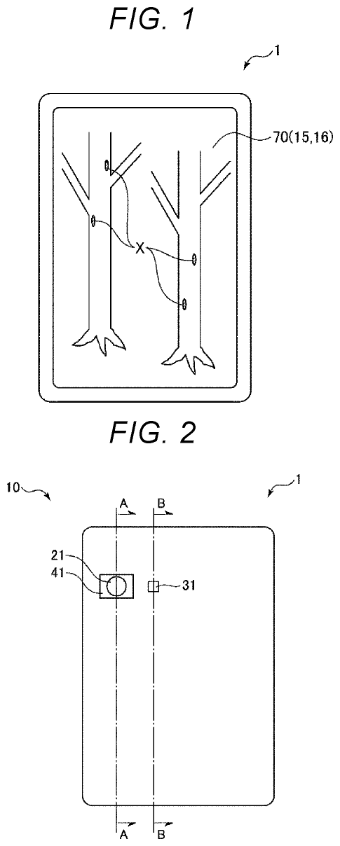

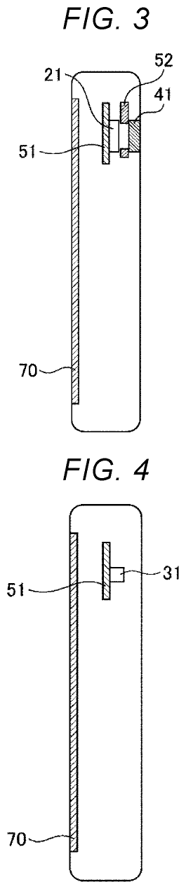

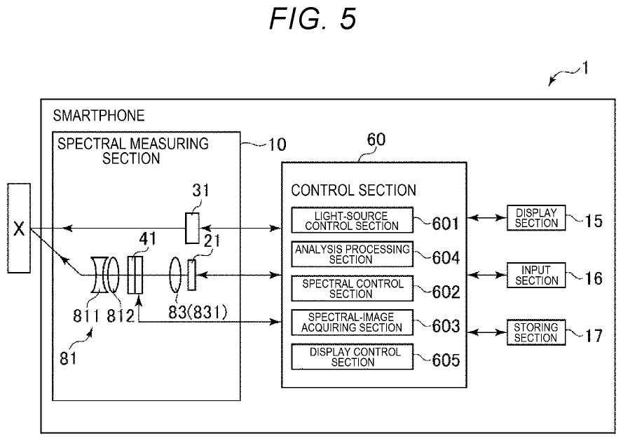

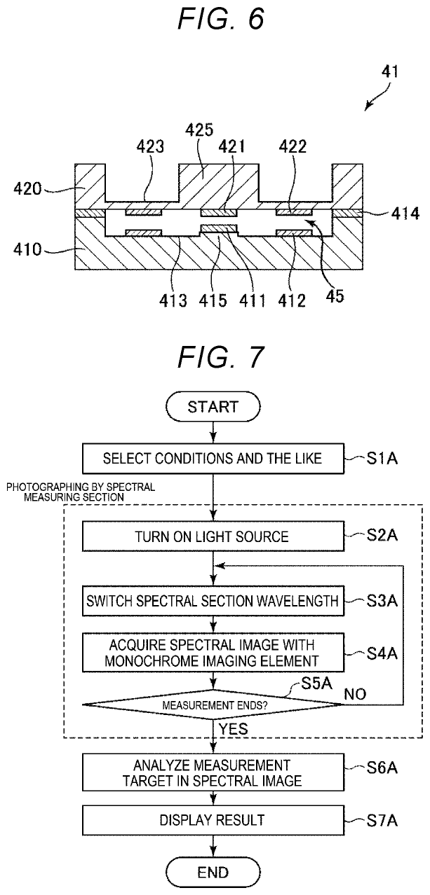

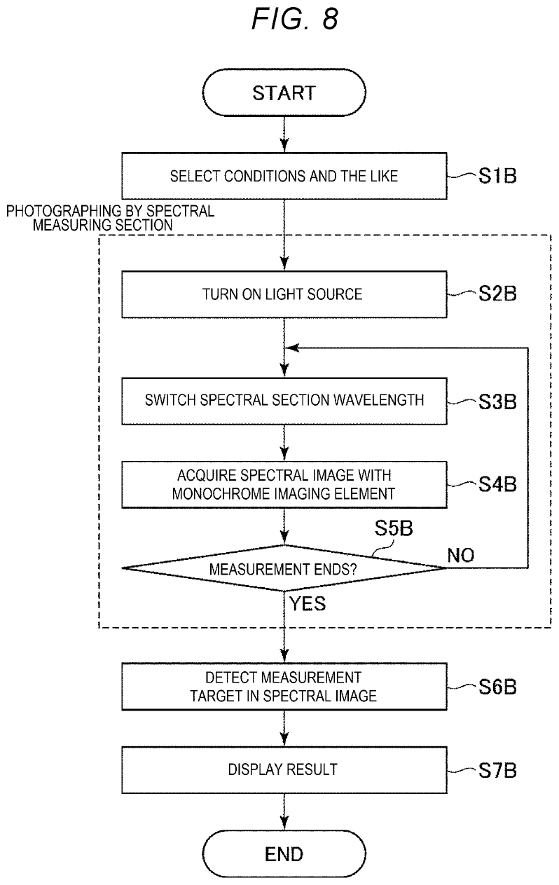

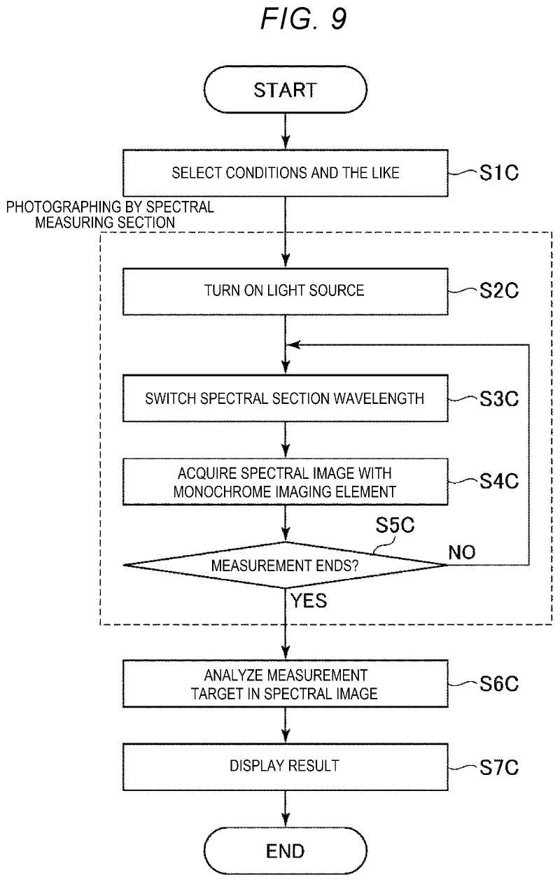

FIG. 1 is a plan view showing a front side of an overall image of a smartphone, which is an information terminal applied with a first embodiment of an information system according to the present disclosure. FIG. 2 is a plan view showing a rear side of the overall image of the smartphone, which is the information terminal applied with the first embodiment of the information system according to the present disclosure. FIG. 3 is an A-A line sectional view of the smartphone shown in FIG. 2. FIG. 4 is a B-B line sectional view of the smartphone shown in FIG. 2. FIG. 5 is a block diagram showing a schematic configuration of the smartphone shown in FIGS. 1 and 2. FIG. 6 is a longitudinal sectional view showing an example in which a wavelength variable interference filter included in a spectral section included in a spectral measuring section of the smartphone shown in FIGS. 1 and 2 is applied to a Fabry-Perot-Etalon filter. FIG. 7 is a flowchart showing a specifying method for specifying a kind of a measurement target with the smartphone shown in FIGS. 1 and 2. FIG. 8 is a flowchart showing a detecting method for detecting the measurement target with the smartphone shown in FIGS. 1 and 2. FIG. 9 is a flowchart showing a judging method for judging the measurement target with the smartphone shown in FIGS. 1 and 2.

In this embodiment, the information system according to the present disclosure is applied to a smartphone 1 (SP), which is a type of an information terminal, that is, the information system according to the present disclosure is completed by the smartphone 1 alone, which is an information terminal.

The smartphone 1 is one of portable information terminals having an imaging function. As shown in FIGS. 1 to 5, the smartphone 1 includes an input section 16 to which conditions for acquiring spectral information of measurement targets (X) (targets) that should be measured are input, a spectral measuring section 10 that acquires the spectral information of the measurement targets X, a storing section 17 in which a plurality of databases including the spectral information of the measurement targets X are stored, a control section 60 including an analysis processing section 604 that specifies the measurement targets X by comparing the spectral information of the measurement targets X and the database stored in the storing section 17 in advance, and a display section 15 that displays information concerning the specified measurement targets X.

In the smartphone 1, the analysis processing section 604 specifies the measurement targets X based on the spectral information acquired by the spectral measuring section 10. That is, in the smartphone 1, the measurement targets X are specified using, as a feature value, the spectral information acquired by the spectral measuring section 10.

In this way, the spectral information is used as the feature value in the smartphone 1. Therefore, as explained above, compared with when shapes and the like of the measurement targets X are used as feature values, it is possible to specify the measurement targets X with excellent specifying accuracy even when “the measurement targets X are similar to a pattern of a background”, when “the measurement targets X are facing the front or the rear”, and when “the measurement targets X are protruding from an imaging region”.

Therefore, when an electronic picture book for specifying kinds of animals, plants, and the like set as the measurement targets X is started as an application included in the smartphone 1, besides the specified kinds of the animals, the plants, and the like, for example, detailed information and the like of the animals, the plants, and the like are displayed on the display section 15. With the smartphone 1, it is possible to specify the kinds with excellent accuracy.

When a detecting method for detecting presence or absence and positions of presence of animals and plants set as the measurement targets X in in a captured image, that is, an imaging region is started as the application, besides kinds of detected animals, plants, and the like and positions where the animals, the plants, and the like are present, for example, a probability of the presence of the animals, the plants, and the like is displayed on the display section 15. With the smartphone 1, it is possible to improve detection accuracy for detecting the animals, the plants, and the like. In FIG. 1, positions of insects such as beetles and stag beetles set as the measurement targets X on trees are specified and displayed on the display section 15.

Further, when a judging method for judging genuineness (authenticity) and degrees of aged deterioration of articles such as bags, wallets, watches, and jewels set as the measurement targets X in a captured image is started as the application, genuineness and degrees of aged deterioration of specified, that is, judged articles and an authenticity rate, positions where the aged deterioration occurs, and the like are displayed on the display section 15. With the smartphone 1, it is possible to improve judgement accuracy for judging articles.

Configurations of the sections included in the smartphone 1 are explained below.

### Display Section 15 and Input Section 16

In the smartphone 1, a display 70 has functions of both of the display section 15 and the input section 16. The display section 15 is configured by, for example, a display device such as a liquid crystal display or an organic EL display. As shown in FIG. 1, the display section 15 is provided on the front side of the smartphone 1 and displays various visualized images including information concerning the specified measurement target X. In the present disclosure, the display section 15 and the input section 16 may be respectively separately provided.

Examples of the visualized images, that is, the information concerning the specified measurement target X displayed on the display section 15 include, besides an image of the specified measurement target X, information such as characteristics, a classification, components, and natures of the measurement target X, presence or absence and a position of the presence of the measurement target X in an imaging region, and recognition accuracy (%) and a presence probability (%) of the measurement target X.

The input section 16 is configured by, for example, a touch panel provided on the surface of the display section 15 and including a touch sensing surface and a sensor for detecting intensity of contact with the touch sensing surface. The input section 16 receives an operation instruction by a user (an operator), that is, conditions and the like for acquiring spectral information of the measurement target X.

### Storing Section 17

The storing section 17 is configured by a storage device (a memory) such as a ROM or a RAM. The storing section 17 stores various data, programs, and the like necessary for control of the smartphone 1, in particular, control of the spectral measuring section 10. Examples of the data include, besides applications and programs for realizing functions of the control section 60, correlated data V-λ data indicating a wavelength of transmitted light with respect to a driving voltage applied to an electrostatic actuator 45 included in a Fabry-Perot-Etalon filter of a spectral section 41 and a database for specifying the measurement target X based on spectral information of the measurement target X. The database indicates spectral information concerning each of animals such as fish and shell fish, insects, and mammals, plants such as flowers and trees, articles such as bags, wallets, watches, and jewels, and the like including the measurement target X that should be specified.

### Spectral Measuring Section 10

The spectrum measurement section 10 is a spectral camera that receives and splits reflected light reflected on the measurement target X to obtain light having a selected specific wavelength or specific wavelength region (hereinafter representatively explained as “specific wavelength”) and thereafter images the light having the specific wavelength to thereby acquire a spectral image, that is, spectral information.

In this embodiment, the spectral measuring section 10 includes a light source 31 that irradiates light on the measurement target X, that is, an imaging target, an imaging element 21 that captures an image based on reflected light reflected on the measurement target X, and a spectral section 41 that is capable of selectively emitting light having a predetermined wavelength from incident light and changing a wavelength region of emitted light to be emitted.

In such a spectral measuring section 10, as shown in FIG. 2, the spectral section 41 is disposed between the imaging element 21 and the measurement target X in a state in which the light source 31 and the imaging element 21 are disposed to face the same direction on the rear surface side of the smartphone 1. By disposing the light source 31, the spectral section 41, and the imaging element 21 in such a positional relation, the spectral measuring section 10 can be configured by a spectral camera of post-dispersive spectroscopy using the light source 31, the spectral section 41, and the imaging element 21. Such a spectral camera of the post-dispersive spectroscopy is capable of acquiring a specific wavelength and a spectral shape and grasp characteristics of the measurement target X by scanning a wavelength in a certain measurement range (a predetermined region). Therefore, the post-dispersive spectroscopy is a scheme effective when the measurement target X, a specific wavelength of which is unknown, is measured, that is, imaged.

The spectral measuring section 10 may configure a spectral camera of pre-dispersive spectroscopy in which the spectral section 41 is disposed between the light source 31 and the measurement target X. Such a pre-dispersive spectroscopy is a scheme capable of grasping characteristics of the measurement target X by irradiating light having a specific wavelength. Therefore, the pre-dispersive spectroscopy is a scheme effective when the measurement target X, a specific wavelength of which is evident, is measured. Since an information amount can be reduced more than in the post-dispersive spectroscopy, the pre-dispersive spectroscopy is a scheme having an advantage that a reduction in a measurement time can be achieved.

Configurations of the sections included in the spectral measuring section 10 are explained below.

### Light Source 31

The light source 31 is a light element that irradiates illumination light toward the measurement target X.

As shown in FIGS. 2 and 4, the light source 31 is disposed, on the rear surface side of the smartphone 1, on a circuit board 51 disposed in a housing of the smartphone 1 to be able to irradiate the illumination light toward the measurement target X.

A spectral section is not disposed between the light source 31 and the measurement target X. Consequently, light emitted from the light source 31 is directly irradiated on the measurement target X.

Examples of such a light source 31 include an LED light source, an OLED light source, a Xenon lamp, and a halogen lamp. A light source capable of irradiating white light having light intensity in an entire wavelength region where spectral measurement is performed by the spectral section 41 configured by a wavelength variable interference filter is desirably used as the light source 31. The light source 31 may include, besides the white light source, a light source capable of irradiating light having a predetermined wavelength such as infrared light.

### Imaging Element 21

The imaging element 21 functions as a detecting section that detects reflected light reflected on the measurement target X by capturing an image based on the reflected light reflected on the measurement target X.

As shown in FIGS. 2 and 3, the imaging element 21 is disposed, on the rear surface side of the smartphone 1, on the circuit board 51 disposed in the housing of the smartphone 1 to be able to receive the reflected light reflected on the measurement target X.

The spectral section 41 is disposed between the imaging element 21 and the measurement target X. Consequently, emitted light having a specific wavelength in incident light made incident on the spectral section 41 from the measurement target X is selectively emitted. The emitted light is imaged as a spectral image, that is, spectral information by the imaging element 21.

Such an imaging element 21 is configured by a CCD, a CMOS, or the like.

### Spectral Section 41

The spectral section 41 is capable of selectively emitting light having a spectral wavelength, which is a specific wavelength, from incident light and changing a wavelength region of emitted light to be emitted. That is, the spectral section 41 emits the light having the specific wavelength toward the imaging element 21 from the incident light as the emitted light.

As shown in FIG. 3, the spectral section 41 is disposed on a circuit board 52 disposed in the housing of the smartphone 1.

The spectral section 41 is disposed between the imaging element 21 and the measurement target X, that is, on an optical axis between the imaging element 21 and the measurement target X. Consequently, the spectral section 41 selectively emits, toward the imaging element 21, the emitted light having the specific wavelength in the incident light made incident on the spectral section 41 from the measurement target X.

Such a spectral section 41 is configured by a wavelength variable interference filter to be capable of changing a wavelength region of emitted light to be emitted. The wavelength variable interference filter is not particularly limited. Examples of the wavelength variable interference filter include a Fabry-Perot-Etalon filter of a wavelength variable type, an acoustic optical tunable filter (AOTF), a linear variable filter (LVF), and a liquid crystal tunable filter (LCTF) that control a wavelength of transmitted reflected light by, for example, adjusting a size of a gap between two filters (mirrors) with an electrostatic actuator. Above all, the wavelength variable interference filter is desirably the Fabry-Perot-Etalon filter.

The Fabry-Perot-Etalon filter extracts reflected light having a desired wavelength making use of multiple interference by two filters. Therefore, a thickness dimension can be set extremely small. Specifically, the thickness dimension can be set to 2.0 mm or less. Accordingly, the smartphone 1 including the spectral section 41 and the spectral measuring section 10 can be reduced in size. Therefore, it is possible to realize a further reduction in the size of the spectral measuring section 10 by using the Fabry-Perot-Etalon filter as the wavelength variable filter.

The spectral section 41 applied with the Fabry-Perot-Etalon filter of the wavelength variable type as the wavelength variable interference filter is explained below with reference to FIG. 6.

The Fabry-Perot-Etalon filter includes is a rectangular tabular optical member in a plan view and includes a fixed substrate 410, a movable substrate 420, a fixed reflection film 411, a movable reflection film 421, a fixed electrode 412, a movable electrode 422, and a joining film 414. The fixed substrate 410, the movable substrate 420, the fixed reflection film 411, the movable reflection film 421, the fixed electrode 412, the movable electrode 422 are integrally joined via the joining film 414 in a state in which the fixed substrate 410 and the movable substrate 420 are laminated.

On the fixed substrate 410, a groove 413 is formed by etching in the depth direction to surround the center of the fixed substrate 410 such that a reflection-film setting section 415 is formed in the center. In the fixed substrate 410 having such a configuration, a fixed optical mirror configured by the fixed reflection film 411 is provided on the movable substrate 420 side of the reflection-film setting section 415 and the fixed electrode 412 is provided on the movable substrate 420 side of the groove 413.

On the movable substrate 420, a holding section, which is a groove 423, is formed by etching in the thickness direction to surround the center of the movable substrate 420 such that a movable section, which is a reflection-film setting section 425, is formed in the center. In the movable substrate 420 having such a configuration, a movable optical mirror configured by the movable reflection film 421 is provided on the fixed substrate 410 side, that is, the lower surface side of the reflection-film setting section 425 and the movable electrode 422 is provided on the fixed substrate 410 side.

Compared with the reflection-film setting section 425, the movable substrate 420 is formed small in the thickness dimension of the groove 423. Consequently, the groove 423 functions as a diaphragm that bends with electrostatic attraction when a voltage is applied between the fixed electrode 412 and the movable electrode 422.

The fixed substrate 410 and the movable substrate 420 can be manufactured at thickness of approximately 0.1 mm or more and 1.0 mm or less. Accordingly, the thickness of the entire Fabry-Perot-Etalon filter can be set to 2.0 mm or less. Therefore, a reduction in the size of the spectral measuring section 10 can be realized.

Between the fixed substrate 410 and the movable substrate 420, the fixed reflection film 411 and the movable reflection film 421 are disposed to be opposed to each other via a gap substantially in the center of the fixed substrate 410 and the movable substrate 420. The fixed electrode 412 and the movable electrode 422 are disposed to be opposed to each other via a gap in a groove section surrounding the center. The electrostatic actuator 45 that adjusts the size of the gap between the fixed reflection film 411 and the movable reflection film 421 is configured by the fixed electrode 412 and the movable electrode 422.

A bend is caused in the holding section, which is the groove 423, by electrostatic attraction generated by applying a voltage between the fixed electrode 412 and the movable electrode 422 configuring the electrostatic actuator 45. As a result, it is possible to change the size of the gap, that is, the distance between the fixed reflection film 411 and the movable reflection film 421. By setting the size of the gap as appropriate, it is possible to select a wavelength of transmitted light and selectively emit light having a desired wavelength (wavelength region) from incident light. By changing the configurations of the fixed reflection film 411 and the movable reflection film 421, it is possible to control a half value width of the transmitted light, that is, the resolution of the Fabry-Perot-Etalon filter.

The fixed substrate 410 and the movable substrate 420 are respectively formed of, for example, glass such as soda glass, crystalline glass, quartz glass, lead glass, potassium glass, borosilicate glass, or non-alkali glass, crystal, or the like. The joining film 414 is formed of, for example, a plasma polymerized film containing siloxane as a main material. Besides being formed of, for example, a metal film of Ag or the like or an alloy film of an Ag alloy or the like, the fixed reflection film 411 and the movable reflection film 421 are formed of a dielectric multilayer film including TiO₂ as a high refractive layer and including SiO₂ as a low refractive layer. Further, the fixed electrode 412 and the movable electrode 422 are formed of a conductive material.

### Optical Systems 81 and 83

In this embodiment, as shown in FIG. 5, the spectral measuring section 10 includes the optical systems 81 and 83 configured by various optical components. The spectral measuring section 10 may be referred to as a spectral measuring sensor.

The optical system 81 on a first spectral section side is disposed between the measurement target X and the spectral section 41 and includes an incident lens 811 functioning as an incident optical system and a projection lens 812 and guides reflected light reflected on the measurement target X to the spectral section 41.

The optical system 83 on a first imaging element side is disposed between the spectral section 41 and the imaging element 21 and includes an incident and exit lens 831 and guides emitted light emitted by the spectral section 41 to the imaging element 21.

The spectral measuring section 10 includes at least one of such optical systems 81 and 83. Consequently, it is possible improve a condensing rate by the imaging element 21 of reflected light reflected on the measurement target X.

At least one of the optical systems 81 and 83 may be omitted considering the condensing rate by the imaging element 21.

Besides being disposed as explained above (see FIG. 5), the optical system 81 on the first spectral section side maybe disposed between the spectral section 41 and the optical system 83 on the first imaging element side.

### Control Section 60

The control section 60 is provided in the housing included in the smartphone 1 and is configured by, for example, one or more processors in which a CPU, a memory, and the like are combined. The control section 60 controls the operation of the sections such as the light source 31, the imaging element 21, and the spectral section 41, that is, the operation of the entire spectral measuring section 10 or the sections of the spectral measuring section 10 and controls the operation of the display section 15 and input and output of data to and from the storing section 17.

More specifically, the control section 60 controls the operation of the light source 31, the spectral section 41, and the imaging element 21 by reading, based on an operation instruction of the user input to the input section 16, that is, conditions for acquiring spectral information of the measurement target X, software such as programs stored in the storing section 17. For example, the control section 60 specifies the imaged measurement target X based on a spectral image obtained by the control and displays, on the display section 15, information such as a kind and characteristics of the measurement target X itself and presence or absence of the measurement target X in the imaging region.

In this embodiment, the control section 60 includes, as shown in FIG. 5, a light-source control section 601, a spectral control section 602, a spectral-image acquiring section 603, an analysis processing section 604, and a display control section 605.

The light-source control section 601 controls turn-on and turn-off of the light source 31 based on an operation instruction of the user input to the input section 16, specifically, conditions for acquiring spectral information of the measurement target X.

The spectral control section 602 acquires, based on V-λ data stored in the storing section 17, a voltage value (an input value) of a driving voltage corresponding to a spectral wavelength, that is, a specific wavelength to be emitted. The spectral control section 602 outputs a command signal in order to apply the acquired voltage value to the electrostatic actuator 45 of the Fabry-Perot-Etalon filter functioning as the spectral section 41. For example, the spectral control section 602 detects changing timing of a measurement wavelength, changes the measurement wavelength, changes a driving voltage according to the change of the measurement wavelength, and determines a measurement end based on various data stored in the storing section 17 and outputs a command signal based on the determination.

The spectral-image acquiring section 603 acquires (images), in the imaging element 21, as a spectral image, that is, spectral information, light amount measurement data (a light receiving amount) based on reflected light reflected on the measurement target X and thereafter causes the storing section 17 to store the acquired spectral image. When causing the storing section 17 to store the spectral image, the spectral-image acquiring section 603 causes the storing section 17 to store a measurement wavelength together with the spectral image.

The analysis processing section 604 acquires, as spectral information, the spectral image and the measurement wavelength, that is, a spectral spectrum of the measurement target X stored in the storing section 17 and performs analysis processing of the spectral image and the spectral spectrum. That is, the analysis processing section 604 specifies the imaged measurement target X by carrying out analysis processing for comparing the spectral spectrum acquired as the spectral information and the database stored in the storing section 17.

The acquisition of the spectral image and the measurement wavelength by the analysis processing section 604 can be directly carried out from the spectral-image acquiring section 603 not via the storing section 17.

The display control section 605 causes the display section 15 to display, as a visualized image, the information concerning the measurement target X specified by the analysis processing section 604.

In the smartphone 1 explained above, by selecting a type of an application to be started, that is, selecting a method of using the smartphone 1, it is possible to use the smartphone 1 as 1) an electronic picture book for specifying kinds of animals, plants, and the like set as the measurement targets X, 2) a detecting device that detects presence or absence of animals, plants, and the like set as the measurement targets X in a captured image and positions where the animals, the plants, and the like are present, and 3) a judging device that judges genuineness (authenticity) and degrees of aged deterioration of articles set as the measurement targets X in a captured image. Methods of using the smartphone 1 as the devices that carry out 1) to 3) are explained below.

### 1) Method of Using the Smartphone 1 as an Electronic Picture Book

A specifying method of specifying kinds of animals, plants, and the like set as the measurement targets X using the smartphone 1 as an electronic picture book is explained in detail below with reference to FIG. 7 and the like.

In the specifying method using the smartphone 1 as the electronic picture book, the measurement target X is imaged using the spectral measuring section 10 and specified based on a captured spectral image. Thereafter, an image, a kind, detailed explanation, and the like of the specified measurement target X are displayed on the display 70.

<1A> First, the user starts, by operating the input section 16, an application used the smartphone 1 as the electronic picture book and thereafter selects conditions and the like when necessary according to an instruction of the application (S1A).

Examples of the conditions input according to the instruction of the application include classifications of flowers, fish, mammals, and the like of the measurement targets X when the classifications are evident. By inputting the classifications of the measurement targets X in advance in this way, it is possible to more quickly perform the detection of the measurement targets X by the smartphone 1.

<2A> Subsequently, the user performs, by operating the input section 16, an input instruction for imaging the measurement target X with the smartphone 1, that is, the spectral measuring section 10. The control section 60 controls the operation of the spectral measuring section 10 and performs imaging of the measurement target X based on the input instruction.

<2A-1> First, the light-source control section 601 turns on the light source 31 according to the input instruction for the imaging of the measurement target X by the user in the input section 16 (S2A).

Illumination light emitted from the light source 31 by the turn-on of the light source 31 is irradiated on the measurement target X. The irradiated light is reflected by the measurement target X and the reflected light is made incident on the spectral section 41 as incident light.

<2A-2> Subsequently, the spectral control section 602 acquires, based on the V-λ data stored in the storing section 17, a voltage value (an input value) of a driving voltage corresponding to a spectral wavelength to be emitted. The spectral control section 602 outputs a command signal in order to apply the acquired voltage value to the electrostatic actuator 45 of the Fabry-Perot-Etalon filter functioning as the spectral section 41 (S3A).

Consequently, light having a specific wavelength in the light made incident on the spectral section 41 from the measurement target X as the incident light is selectively emitted toward the imaging element 21 side as emitted light.

Prior to causing the spectral section 41 to emit the light having the specific wavelength, the spectral control section 602 desirably applies adjustment processing for performing calibration of the spectral section 41. Consequently, the spectral control section 602 acquires a spectral spectrum s_{ref} of the light source 31.

<2A-3> Subsequently, the spectral-image acquiring section 603 controls the operation of the imaging element 21 to acquire, with the imaging element 21, as a spectral image, the light having the specific wavelength emitted from the spectral section 41 as the emitted light. That is, the spectral-image acquiring section 603 acquires, with the imaging element 21, as a spectral image, light amount measurement data (a light receiving amount) in the light having the specific wavelength in the reflected light reflected on the measurement target X. The spectral-image acquiring section 603 causes the storing section 17 to store the acquired spectral image together with the measurement wavelength (S4A).

In such an acquiring method for a spectral image, the spectral section 41 is disposed on an optical axis of received light of the imaging element 21 between the measurement target X and the imaging element 21. Consequently, only the light having the specific wavelength of the light reflected by the measurement target X is transmitted by the spectral section 41. The intensity of the light having the specific wavelength is spectrally measured by the imaging element 21.

<2A-4> Subsequently, the spectral-image acquiring section 603 determines based on the conditions and the like selected by the user in the step <1A> whether, after acquisition of a spectral image in light having a wavelength in a first time, acquisition of a spectral image in light having a wavelength in a second time different from the wavelength in the first time is necessary. That is, the spectral-image acquiring section 603 determines whether it is necessary to continuously acquire a spectral image in the light having the wavelength in the second time different from the wavelength in the first time (S5A).

When it is necessary to acquire a spectral image in the light having the wavelength in the second time in this determination (S5A), the control section 60 repeatedly carries out the step <2A-2> to the step <2A-4> concerning the light having the wavelength in the second time instead of the light having the wavelength in the first time. That is, the control section 60 changes a voltage value applied between the fixed electrode 412 and the movable electrode 422 of the electrostatic actuator 45 and sets the voltage value in the wavelength in the second time and thereafter repeatedly carries out the step <2A-2> to the step <2A-4>. Consequently, the control section 60 acquires a spectral image in the light having the wavelength in the second time. The control section 60 repeatedly carries out, in the first and second times to an n-th time, such acquisition of a spectral image in the light having the wavelength in the second time, that is, the different wavelength. As explained above, by repeatedly carrying out the step <2A-2> to the step <2A-4>, it is possible to obtain spectrum information sₛₐₘ indicating a relation between wavelengths and light intensities corresponding to pixels of spectral images.

On the other hand, when it is unnecessary to acquire a spectral image in light having the next wavelength, the control section 60 ends the acquisition of a spectral image by the spectral measuring section 10 and shifts to the next step <3A>.

<3A> Subsequently, the analysis processing section 604 carries out an analysis of the spectral image based on the spectral image and the measurement wavelength of the measurement target X, that is, the spectrum information sₛₐₘ stored in the storing section 17 (S6A).

In other words, the analysis processing section 604 acquires the spectrum information sₛₐₘ stored in the storing section 17 in the step <2A>. Thereafter, the analysis processing section 604 carries out the analysis processing for comparison with the database using the spectrum information sₛₐₘ as a feature value having the spectral information to specify the imaged measurement target X.

Specifically, the analysis processing section 604 calculates reflectance r=sₛₐₘ/s_{ref} of the measurement target X from the spectrum information sₛₐₘ and the spectral spectrum s_{ref} of the light source 31.

The analysis processing section 604 acquires data rⁱ included in data corresponding to groups i=1, , and M stored in the storing section 17 in advance and determines, using rⁱ, whether reflectance r of the measurement target X belongs to the group i to specify the measurement target X. “Groups” refers to classifications such as flowers, fish, and mammals to which the measurement target X belongs. When a classification of the measurement target X is input in advance in the step <1A>, data of a group corresponding to the classification of the measurement target X is acquired. When a classification of the measurement target X is not input in the step <1A>, data of the groups are sequentially acquired until the measurement target X is specified.

More in detail, first, the analysis processing section 604 generates, based on a specific determination standard, a projection function f(·) for projecting spectral data serving as a feature value to a determination space suitable for determining to which group the measurement target X belongs. Examples of the determination standard include a Fischer determination standard and a least square standard. The analysis processing section 604 projects the reflectance r of the measurement target X to the determination space as y.

y=f(r)

Similarly, the analysis processing section 604 projects the data rⁱ of the groups i=1, , and M to the determination space as y(rⁱ). The analysis processing section 604 calculates distances mⁱ(i=1, , and M) in the determination space between the position y on the determination space of the measurement target X and the groups i=1, , and M.

mⁱ(i=1, , and M)=g(y, y(rⁱ))

In the above expression, y(rⁱ) is a set of positions on the determination space of data belonging to the group i, that is, y(rⁱ)={y(rⁱ·1), , and y(rⁱ_{N})} (in the expression, N represents the number of data belonging to the group i) and g(a, b) is a function for calculating a distance between “a” and “b” in the determination space. As the distance, a Mahalanobis distance, a Euclidian distance, and the like can be used. In mⁱ(i=1, , and M), a smallest distance is specified. A group corresponding to the smallest distance is specified as a group H to which the measurement target X belongs.

H=argᵢ min·mⁱ

As explained above, in the step <3A>, the spectrum information, that is, the spectral information is used as the feature value for specifying the measurement target X and the measurement target X is specified based on the shape of the spectral information. Therefore, even if a measurement target and a background have similar colors as when “the measurement target X is similar to a pattern of a background”, for example, when a “matsutake mushroom” present in withered pine leaves, a “green caterpillar” present on a leave, “flatfish or flounder” present on a sandy beach, or a “stag beetle” or a “beetle” present on a branch of a tree is specified set as the measurement target X. Further, even when “the measurement target X is facing the front and the rear in an imaging region” and when “the measurement target X is protruding from the imaging region”, since shape information is not used as a feature value, the measurement target X can be accurately specified.

<4A> Subsequently, the display control section 605 creates, as a visualized image, the information concerning the measurement target X specified by the analysis processing section 604 and thereafter causes the display 70 including the display section 15 to display the visualized image (S7A).

Examples of the information concerning the measurement target X that the display control section 605 causes the display 70 to display as the visualized image include, when the measurement target X is an animal such as a fish and shellfish, an insect, or a mammal or a plant such as a flower or a tree, besides the specified kind of the measurement target X, that is, the group H to which the measurement target X belongs, detailed information such as a classification, a distribution, a form, and ecology of the measurement target X.

The information stored in the storing section 17 is displayed on the display 70. However, the display control section 605 can also cause the display 70 to display information disclosed on the Internet using a communication function of the smartphone 1.

The measurement target X is specified through the step <1A> to the step <4A> in which the smartphone 1 is used as the electronic picture book as explained above.

In the above explanation, the analysis processing for comparing the spectral spectrum serving as the spectral information and the database stored in the storing section 17 is carried out using the distance mi(i=1, , and M) in the determination space. However, not only this, but the analysis processing can also be carried out by machine learning such as a neural network.

The specifying the measurement target X using the smartphone 1 as the electronic picture book can be applied to, besides the specifying the animal or the plant as explained above, for example, specifying a mineral such as a jewel, a vehicle such as a train or a car, cloud, a constellation, and the like.

### 2) Method of Using the Smartphone 1 as a Detecting Device

A detecting method for detecting, using the smartphone 1 as a detecting device, presence or absence of animals, plants, and the like set as the measurement targets X (targets), presence of which is desired to be specified, and positions where the animals, the plants, and the like are present is explained in detail below with reference to FIG. 8 and the like.

In the detecting method using the smartphone 1 as the detecting device, a region where the measurement target X, that is, a detection target is assumed to be present is imaged using the spectral measuring section 10 and presence or absence of the measurement target X, a position where the measurement target X is present, a presence probability (%), and the like in the imaged imaging region are specified based on a captured spectral image. Thereafter, the specified contents are displayed on the display 70.

<1B> First, the user starts, by operating the input section 16, an application for using the smartphone 1 as the detecting device and thereafter selects conditions and the like according to an instruction of the application (S1B).

Examples of the conditions input according to the instruction of the application include a kind and the like of the measurement target X that the user desires to detect in a captured image.

<2B> Subsequently, the user performs, by operating the input section 16, an input instruction for imaging, with the smartphone 1, that is, the spectral measuring section 10, a region where the user desires to detect the measurement target X. Based on the input instruction, the control section 60 controls the operation of the spectral measuring section 10 and performs imaging of the imaging region where the user desires to detect the measurement target X.

<2B-1> First, the light-source control section 601 turns on the light source 31 according to the input instruction for imaging by the user in the input section 16 (S2B).

Illumination light emitted from the light source 31 by the turn-on of the light source 31 is irradiated on the imaging region where the measurement target X is detected. The irradiated light is reflected in the imaging region and the reflected light is made incident on the spectral section 41 as incident light.

<2B-2> Subsequently, the spectral control section 602 acquires, based on the V-λ data stored in the storing section 17, a voltage value (an input value) of a driving voltage corresponding to a spectral wavelength to be emitted. The spectral control section 602 outputs a command signal in order to apply the acquired voltage value to the electrostatic actuator 45 of the Fabry-Perot-Etalon filter functioning as the spectral section 41 (S3B).

Consequently, light having a specific wavelength in the light made incident on the spectral section 41 from the measurement target X as the incident light is selectively emitted toward the imaging element 21 side as emitted light.

Prior to causing the spectral section 41 to emit the light having the specific wavelength, the spectral control section 602 desirably applies adjustment processing for performing calibration of the spectral section 41. Consequently, the spectral control section 602 acquires the spectral spectrum s_{ref} of the light source 31.

<2B-3> Subsequently, the spectral-image acquiring section 603 controls the operation of the imaging element 21 to acquire, with the imaging element 21, as a spectral image, the light having the specific wavelength emitted from the spectral section 41 as the emitted light. That is, the spectral-image acquiring section 603 acquires, with the imaging element 21, as a spectral image, light amount measurement data (a light receiving amount) in the light having the specific wavelength in the reflected light reflected on the measurement target X. The spectral-image acquiring section 603 causes the storing section 17 to store the acquired spectral image together with the measurement wavelength (S4B).

In such an acquiring method for a spectral image, the spectral section 41 is disposed on an optical axis of received light of the imaging element 21 between the imaging region where the user desires to detect the measurement target X and the imaging element 21. Consequently, only the light having the specific wavelength in the light reflected by the measurement target X is transmitted by the spectral section 41. The intensity of the light having the specific wavelength is spectrally measured by the imaging element 21.

<2B-4> Subsequently, the spectral-image acquiring section 603 determines based on the conditions and the like selected by the user in the step <1B> whether, after acquisition of a spectral image in light having a wavelength in a first time, acquisition of a spectral image in light having a wavelength in a second time different from the wavelength in the first time is necessary. That is, the spectral-image acquiring section 603 determines whether it is necessary to continuously acquire a spectral image in the light having the wavelength in the second time different from the wavelength in the first time (S5B).

When it is necessary to acquire a spectral image in the light having the wavelength in the second time in this determination (S5B), the control section 60 repeatedly carries out the step <2B-2> to the step <2B-4> concerning the light having the wavelength in the second time instead of the light having the wavelength in the first time. That is, the control section 60 changes the magnitude of a voltage applied between the fixed electrode 412 and the movable electrode 422 of the electrostatic actuator 45 and sets the magnitude of the voltage in the wavelength in the second time and thereafter repeatedly carries out the step <2B-2> to the step <2B-4>. Consequently, the control section 60 acquires a spectral image in the light having the wavelength in the second time. The control section 60 repeatedly carries out, in the first and second times to an n-th time, such acquisition of a spectral image in the light having the wavelength in the second time, that is, the different wavelength. As explained above, by repeatedly carrying out the step <2B-2> to the step <2B-4>, it is possible to obtain spectrum information sₛₐₘ indicating a relation between wavelengths and light intensities corresponding to pixels in the imaging region where the user desires to detect the measurement target X.

On the other hand, when it is unnecessary to acquire a spectral image in light having the next wavelength, the spectral measuring section 10 ends the acquisition of a spectral image by the spectral measuring section 10 and shifts to the next step <3B>.

<3B> Subsequently, the analysis processing section 604 carries out an analysis of the spectral image based on the spectral image and the measurement wavelength of the measurement target X, that is, the spectrum information sₛₐₘ stored in the storing section 17 (S6B).

In other words, the analysis processing section 604 acquires the spectrum information sₛₐₘ stored in the storing section 17 in the step <2B>. Thereafter, the analysis processing section 604 carries out the analysis processing using the spectrum information sₛₐₘ as a feature value having the spectral information to detect the imaged measurement target X, which is a target object, from the imaging region imaged by the spectral measuring section 10.

Specifically, the analysis processing section 604 calculates, from the spectrum information sₛₐₘ and the spectral spectrum s_{ref} of the light source 31, reflectance r=sₛₐₘ/s_{ref} in the imaging region where the user desires to detect the measurement target X. The analysis processing section 604 divides the imaging region into M rows and N columns to calculate data rⁱⱼ corresponding to divided M×N regions (i=1, , and M), (j=1, , and N).

The analysis processing section 604 acquires reflectance r_{base} corresponding to the measurement target X in the database prepared in advance in the storing section 17 and determines whether reflectance rⁱⱼ corresponding to the M divided regions belongs to the reflectance r_{base} corresponding to the measurement target X to specify a position where the measurement target X is present.

More in detail, first, the analysis processing section 604 generates, based on a specific determination standard, a projection function f(·) for projection to a determination space suitable for determining the regions. Examples of the determination standard include a Fischer determination standard and a least square standard. The analysis processing section 604 projects the reflectance r_{base} of the measurement target X saved in the database to the determination space as y.

y=f(r_{base})

Similarly, the analysis processing section 604 projects the data rⁱⱼ corresponding to the regions (i=1, , and M), (j=1, , and N) divided into the M rows and the N columns to the determination space as y(rⁱⱼ). The analysis processing section 604 calculates distances mⁱⱼ(i=1, , and M), (j=1, , and N) in the determination space between the measurement target X and the regions (i=1, , and M), (j=1, , and N).

mⁱⱼ(i=1, , and M), (j=1, , and N)=g(y, y(rⁱⱼ))

In the expression, g( ) is a function for calculating a distance in the determination space. As the distance, a Mahalanobis distance, a Euclidian distance, and the like can be used.

When a distance among the distances mⁱⱼ(i=1, , and M), (j=1, , and N) is smaller than a set certain threshold, the analysis processing section 604 can determine that the measurement target X has a probability of presence in the region and specify a presence probability (%) in such a region by subdividing the threshold.

As explained above, in the step <3B>, the spectrum information, that is, the spectral information is used as the feature value for specifying the measurement target X. Therefore, even if a measurement target and a background have similar colors as when “the measurement target X is similar to a pattern of a background”, for example, when a “matsutake mushroom” present in withered pine leaves, a “green caterpillar” present on a leave, “flatfish or flounder” present on a sandy beach, or a “stag beetle” or a “beetle” present on a branch of a tree is detected as the measurement target X. Further, even when “the measurement target X is facing the front and the rear in an imaging region” and when “the measurement target X is protruding from the imaging region”, since shape information is not used as a feature value, the measurement target X can be accurately detected.

<4B> Subsequently, the display control section 605 creates a visualized image highlighted by applying, for example, marking of red or the like to a region where it is determined by the analysis processing section 604 that the measurement target X is present in the imaging region imaged by the spectral measuring section 10. Thereafter, as shown in FIG. 1, the display control section 605 causes the display 70 including the display section 15 to display the visualized image (S7B). In FIG. 1, positions where insects such as beetles and stag beetles set as the measurement targets X are in the trees are marked and highlighted to be specified on the display section 15.

In the visualized image, besides the marking on the region where it is determined that the measurement target X is present, for example, a presence probability (%) of presence of the measurement target X may be displayed near the marking or a color of the marking may be changed according to the presence probability (%) of the presence of the measurement target X.

Presence or absence of the measurement target X and a position where the measurement target X is present in the imaging region where the measurement target X is assumed to be present can be detected through the step <1B> to the step <4B> in which the smartphone 1 is used as the detecting device as explained above.

The detecting the measurement target X in the imaging region using the smartphone 1 as the detecting device can be applied to, besides the specifying the animal or the plant as explained above, for example, detecting a mineral such as a jewel, cloud, a constellation, and the like.

### 3) Method of Using the Smartphone 1 as a Judging Device

A judging method for judging, using the smartphone 1 as a judging device, genuineness (authenticity) and degrees of aged deterioration of articles such as bags, wallets, watches, and jewels set as the measurement targets X is explained in detail below with reference to FIG. 9 and the like.

In the judging method using the smartphone 1 as the judging device, the measurement target X that should be judged is imaged using the spectral measuring section 10 and genuineness or a degree of aged deterioration of the measurement target X is judged based on a captured spectral image. Thereafter, the judged contents are displayed on the display 70.

<1C> First, the user starts, by operating the input section 16, or an input interface, an application for using the smartphone 1 as the detecting device and thereafter selects conditions and the like when necessary according to an instruction of the application (S1C).

Examples of the conditions input according to the instruction of the application include a kind and the like of the measurement target X that the user desires to detect in a captured image.

<2C> Subsequently, the user performs, by operating the input section 16, an input instruction for imaging the measurement target X with the smartphone 1, that is, the spectral measuring section 10. Based on the input instruction, the control section 60 controls the operation of the spectral measuring section 10 and performs imaging of the measurement target X.

<2C-1> First, the light-source control section 601 turns on the light source 31 according to the input instruction for imaging of the measurement target X by the user in the input section 16 (S2C).

Illumination light emitted from the light source 31 by the turn-on of the light source 31 is irradiated on the measurement target X. The irradiated light is reflected by the measurement target X and the reflected light is made incident on the spectral section 41 as incident light.

<2C-2> Subsequently, the spectral control section 602 acquires, based on the V-λ data stored in the storing section 17, a voltage value (an input value) of a driving voltage corresponding to a spectral wavelength to be emitted. The spectral control section 602 outputs a command signal in order to apply the acquired voltage value to the electrostatic actuator 45 of the Fabry-Perot-Etalon filter functioning as the spectral section 41 (S3C).

Consequently, light having a specific wavelength in the light made incident on the spectral section 41 from the measurement target X as the incident light is selectively emitted toward the imaging element 21 side as emitted light.

Prior to causing the spectral section 41 to emit the light having the specific wavelength, the spectral control section 602 desirably applies adjustment processing for performing calibration of the spectral section 41. Consequently, the spectral control section 602 acquires the spectral spectrum s_{ref} of the light source 31.

<2C-3> Subsequently, the spectral-image acquiring section 603 controls the operation of the imaging element 21 to acquire, with the imaging element 21, as a spectral image, the light having the specific wavelength emitted from the spectral section 41 as the emitted light. That is, the spectral-image acquiring section 603 acquires, with the imaging element 21, as a spectral image, light amount measurement data (a light receiving amount) in the light having the specific wavelength in the reflected light reflected on the measurement target X. The spectral-image acquiring section 603 causes the storing section 17 to store the acquired spectral image together with the measurement wavelength (S4C).

In such an acquiring method for a spectral image, the spectral section 41 is disposed on an optical axis of received light of the imaging element 21 between the measurement target X and the imaging element 21. Consequently, only the light having the specific wavelength in the light reflected by the measurement target X is transmitted by the spectral section 41. The intensity of the light having the specific wavelength is spectrally measured by the imaging element 21.

<2C-4> Subsequently, the spectral-image acquiring section 603 determines based on the conditions and the like selected by the user in the step <1C> whether, after acquisition of a spectral image in light having a wavelength in a first time, acquisition of a spectral image in light having a wavelength in a second time different from the wavelength in the first time is necessary. That is, the spectral-image acquiring section 603 determines whether it is necessary to continuously acquire a spectral image in the light having the wavelength in the second time different from the wavelength in the first time (S5C).

When it is necessary to acquire a spectral image in the light having the wavelength in the second time in this determination (S5C), the control section 60 repeatedly carries out the step <2C-2> to the step <2C-4> concerning the light having the wavelength in the second time instead of the light having the wavelength in the first time. That is, the control section 60 changes a voltage value applied between the fixed electrode 412 and the movable electrode 422 of the electrostatic actuator 45 and sets the voltage value in the wavelength in the second time and thereafter repeatedly carries out the step <2C-2> to the step <2C-4>. Consequently, the control section 60 acquires a spectral image in the light having the wavelength in the second time. The control section 60 repeatedly carries out, in the first and second times to an n-th time, such acquisition of a spectral image in the light having the wavelength in the second time, that is, the different wavelength. As explained above, by repeatedly carrying out the step <2C-2> to the step <2C-4>, it is possible to obtain spectrum information sₛₐₘ indicating a relation between wavelengths and light intensities corresponding to pixels of the spectral image.

On the other hand, when it is unnecessary to acquire a spectral image in light having the next wavelength, the spectral measuring section 10 ends the acquisition of a spectral image by the spectral measuring section 10 and shifts to the next step <3C>.

<3C> Subsequently, the analysis processing section 604 carries out an analysis of the spectral image based on the spectral image and the measurement wavelength of the measurement target X, that is, the spectrum information sₛₐₘ stored in the storing section 17 (S6C).

In other words, the analysis processing section 604 acquires the spectrum information sₛₐₘ stored in the storing section 17 in the step <2C>. The analysis processing section 604 performs analysis processing using the spectrum information sₛₐₘ as a feature value having spectral information to carry out judgment of the imaged measurement target X.

Specifically, the analysis processing section 604 calculates reflectance r=sₛₐₘ/s_{ref} of the measurement target X from the spectrum information sₛₐₘ and the spectral spectrum s_{ref} of the light source 31.

The analysis processing section 604 acquires reflectance rⁱ equivalent to a genuine product (i=x) of the measurement target X from the data rⁱ corresponding to the groups i=1, , and M stored in the storing section 17 in advance and determines, using rⁱ, whether reflectance r of the measurement target X is equivalent to the reflectance rⁱ of the genuine product to judge the measurement target X.

More in detail, first, the analysis processing section 604 generates, based on a specific determination standard, a projection function f(·) to a determination space suitable for determining the groups. Examples of the determination standard include a Fischer determination standard and a least square standard.

When a type of the judgement is genuineness of an article, the analysis processing section 604 projects the reflectance r of the measurement target X to the determination space as y.

y=f(r)

Similarly, the analysis processing section 604 projects the data rⁱ of a new genuine product (i=x) to the determination space as y(rⁱ). The analysis processing section 604 calculates a distance mⁱ(i=x) in the determination space between the position y on the determination space of the measurement target X and the genuine product (i=x).

mⁱ(i=x)=g(y, y(rⁱ))

In the above expression, g( ) is a function for calculating a distance in the determination space. As the distance, a Mahalanobis distance, a Euclidian distance, and the like can be used.

When the magnitude of mⁱ(i=x) is smaller than a set threshold, the analysis processing section 604 can determine that the measurement target X is a genuine product and specify, by subdividing the threshold, a probability (%) that the measurement target X is the genuine product.

When the type of the judgment is a degree of aged deterioration of an article, the analysis processing section 604 projects the reflectance r of the measurement target X to the determination space as y.

y=f(r)

Similarly, the analysis processing section 604 projects the data rⁱ of genuine products (i=1, , and M) to the determination space as y(rⁱ). The analysis processing section 604 calculates distances mⁱ(i=1, , and M) in the determination space between the position y on the determination space of the measurement target X and the genuine products (i=1, , and M).

mⁱ(i=1, , and M)=g(y, y(rⁱ))

In the above expression, y(rⁱ) is a set of positions on the determination space of data belonging to the genuine product, that is, y(rⁱ)={y(rⁱ·1), , and y(rⁱ_{N})} (in the expression, N represents the number of data belonging to the group i) and g(a, b) is a function for calculating a distance between “a” and “b” in the determination space. As the distance, a Mahalanobis distance, a Euclidian distance, and the like can be used.

When the magnitude of mⁱ(i=1, , and M) is smaller than the set threshold, the analysis processing section 604 can judge that the degree of aged deterioration is a degree of aged deterioration designated in the group i to which the measurement target X belongs.

<4C> Subsequently, the display control section 605 creates, as a visualized image, the information concerning the measurement target X specified by the analysis processing section 604 and thereafter causes the display 70 including the display section 15 to display the visualized image (S7C).

On the visualized image, besides an image of the judged measurement target X, when a segmentation of the judgment is genuineness of the measurement target X, a determination result concerning whether the measurement target X is a genuine product and information such as a probability (%) of the genuine product are displayed. When the segmentation of the judgment is a degree of aged deterioration of the measurement target X, a degree (%) of deterioration of the measurement target X and information such as an assessed price based on the degree (%) of the deterioration of the measurement target X are displayed. When the segmentation of the judgment is genuineness of the measurement target X and a judgment result that the measurement target X is the genuine product is obtained by the judgment, the analysis processing section 604 may automatically shift to judgment of a degree of aged deterioration of the measurement target X.

The judgment of the measurement target X is carried out through the step <1C> to the step <4C> in which the smartphone 1 is used as the judging device.

Besides being applied to the articles such as bags, wallets, watches, and jewels, the judgment of the measurement target X using the smartphone 1 as the judging device can also be applied to specifying of animals, plants, cloud, constellations, and the like when the judging device is used for judging genuineness of the measurement target X.

Further, in this embodiment, the measurement target X is specified using the reflectance of the measurement target X as the spectral information. However, not only this, but the measurement target X can be specified, for example, when transmittance, absorbance, Kubelka-Munk conversion data, and the like of the measurement target X is used as the spectral information.

In this embodiment, the spectral measuring section 10 includes the light source 31, the spectral section 41, and the imaging element 21 as the spectral camera. However, the light source 31 maybe omitted in the spectral measuring section 10. In this case, the irradiation of the light on the measurement target X is carried out by external light such as the sun or indoor illumination in the steps <2A>, <2B>, and <2C> in which the spectral image is captured by the spectral measuring section 10.

Further, in this embodiment, the smartphone 1 is explained as an example assuming that the information system according to the present disclosure is completed by the information terminal alone. However, such an information terminal is not limited to the smartphone 1 and may be, for example, a tablet terminal, a notebook personal computer, a digital camera, a digital video camera, a vehicle-mounted monitor, or a drive recorder. As in this embodiment, by configuring the information system according to the present disclosure to be completed by the information terminal alone, offline use of the information system can be realized. Therefore, the information system can be used in a place where a communication state is unstable.

In this embodiment, the input section 16 is configured by the touch panel. However, the input section 16 is not limited to this and may be an operation button provided in the housing of the smartphone 1, may be an input section to which voice is input via a microphone included in the smartphone 1, or may be a combination of the operation button and the input section.

### Second Embodiment

A second embodiment of the information system according to the present disclosure is explained.

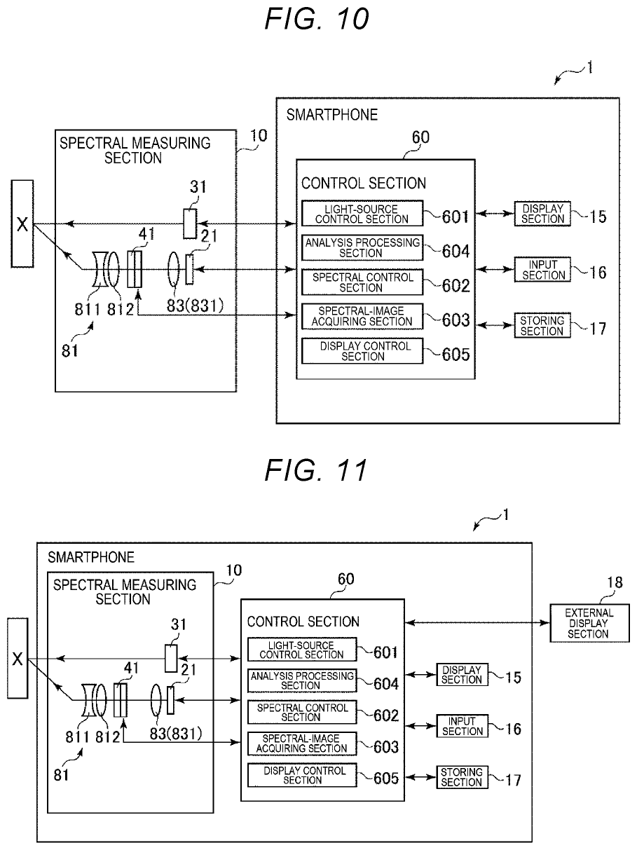

FIG. 10 is a block diagram showing a schematic configuration of a smartphone and a spectral measuring section applied with the second embodiment of the information system according to the present disclosure.

In the following explanation, concerning an information system in the second embodiment, differences from the information system in the first embodiment is mainly explained. Explanation of similarities to the information system in the first embodiment is omitted.

The information system in the second embodiment shown in FIG. 10 is the same as the information system in the first embodiment except that the information system in the second embodiment independently includes the spectral measuring section 10 besides the smartphone 1 functioning as the information terminal and the spectral measuring section 10 exerts a function of a spectral camera. That is, in the information system in the second embodiment, the information system according to the present disclosure is not completed by the smartphone 1 alone, which is the information terminal, and includes the smartphone 1 functioning as the information terminal and the spectral measuring section 10 functioning as the spectral camera.

In the information system in the second embodiment, as shown in FIG. 10, the disposition of the spectral measuring section 10 on the inside of the smartphone 1 is omitted. Instead, the spectral measuring section 10 is independently provided on the outside of the smartphone 1 as the spectral camera. The operation of the spectral measuring section 10 can be controlled by the smartphone 1. The control of the spectral measuring section 10 by the smartphone 1 by electric coupling of the smartphone 1 and the spectral measuring section 10 may be performed by either wire or radio.

In the information system in the second embodiment having such a configuration, acquisition of an image including the measurement target X by the spectral measuring section 10 and operation such as setting of conditions for specifying the measurement target X by the smartphone 1 can be independently carried out. Therefore, it is possible to improve operability of the information system.

The information system according to the present disclosure can be used by installing an application in the smartphone 1 and coupling the spectral measuring section 10 to the smartphone 1. The information system is excellent in versatility because the smartphone 1 not including the spectral measuring section 10 can be used.

Further, by configuring the information system according to the present disclosure to be completed by the smartphone 1 and the spectral measuring section 10, offline use of the information system is possible for communication other than communication between the smartphone 1 and the spectral measuring section 10. Therefore, the information system can be used in a place where a communication state is unstable.

The same effects as the effects of the first embodiment can be obtained by the information system in the second embodiment.

In this embodiment, the information system according to the present disclosure includes the smartphone 1 functioning as the information terminal and the spectral measuring section functioning as the spectral camera. However, in the information system according to the present disclosure, instead of the smartphone 1, the information terminal may be configured by a tablet terminal or the like. The smartphone 1, that is, the information terminal may be configured by a server or the like.

### Third Embodiment

A third embodiment of the information system according to the present disclosure is explained.

FIG. 11 is a block diagram showing a schematic configuration of a smartphone and an external display section applied with the third embodiment of the information system according to the present disclosure.

In the following explanation, concerning an information system in the third embodiment, differences from the information system in the first embodiment are mainly explained. Explanation of similarities to the information system in the first embodiment is omitted.

The information system in the third embodiment shown in FIG. 11 is the same as the information system in the first embodiment except that the information system in the third embodiment independently includes an external display section 18 besides the smartphone 1 functioning as the information terminal and the external display section 18 exerts a function of a display section on the outside of the smartphone 1. That is, in the information system in the third embodiment, the information system according to the present disclosure is not completed by the smartphone 1 alone, which is the information terminal, and includes the smartphone 1 functioning as the information terminal and the external display section 18.

As shown in FIG. 11, the information system in the third embodiment includes, besides the display section 15 included in the smartphone 1, the external display section 18 independently provided on the outside of the smartphone 1. The operation of the external display section 18 can be controlled by the smartphone 1. The control of the external display section 18 by the smartphone 1 by electric coupling of the smartphone 1 and the external display section 18 may be performed by either wire or radio.

In the information system in the third embodiment having such a configuration, confirmation by an operator of an image in the external display section 18 and operation such as setting of conditions for specifying the measurement target X by the smartphone 1 can be independently carried out. Therefore, it is possible to improve operability of the information system.

By configuring the information system according to the present disclosure to be completed by the smartphone 1 and the external display section 18, offline use of the information system is possible for communication other than communication between the smartphone 1 and the external display section 18. Therefore, the information system can be used in a place where a communication state is unstable.

Examples of the external display section 18 include a mobile notebook PC, a tablet terminal, a head-up display (HUD), a head-mounted display (HMD). Above all, the external display section 18 is desirably the head-mounted display. With the head-mounted display, for example, a specified result of the measurement target X and a position where the measurement target X is assumed to be present can be displayed in augmented reality (AR). Further, since hand-free use of the head-mounted display is possible, it is possible to further improve operability of the information system.

The same effects as the effects in the first embodiment can be obtained by the information system in the third embodiment.

### Fourth Embodiment

A fourth embodiment of the information system according to the present disclosure is explained.

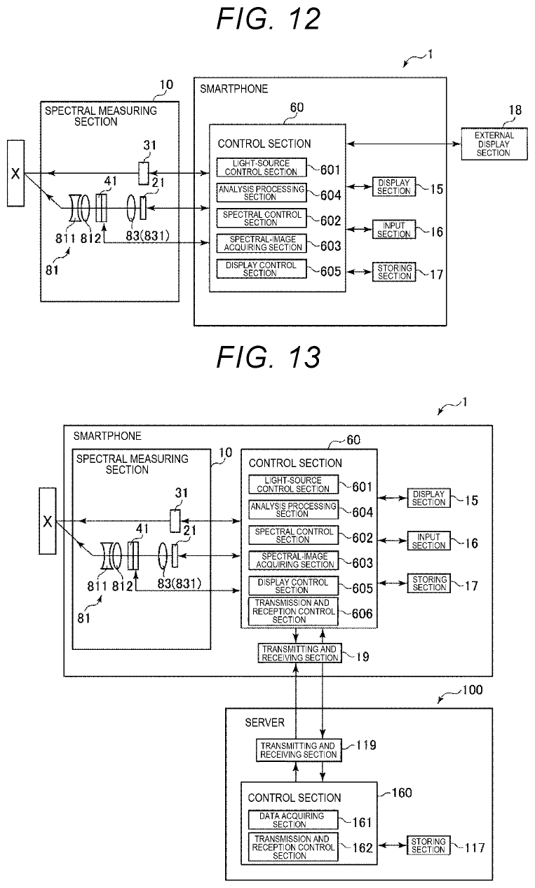

FIG. 12 is a block diagram showing a schematic configuration of a smartphone, a spectral measuring section, and an external display section applied with the fourth embodiment of the information system according to the present disclosure.

In the following explanation, concerning an information system in the fourth embodiment, differences from the information system in the first embodiment are mainly explained. Explanation of similarities to the information system in the first embodiment is omitted.

The information system in the fourth embodiment shown in FIG. 12 is the same as the information system in the first embodiment except that the information system in the fourth embodiment independently includes the spectral measuring section 10 and the external display section 18 besides the smartphone 1 functioning as the information terminal and the spectral measuring section 10 exerts a function of a spectral camera and the external display section 18 exerts a function of a display section on the outside of the smartphone 1. That is, in the information system in the fourth embodiment, the information system according to the present disclosure is not completed by the smartphone 1 alone, which is the information terminal, and includes the smartphone 1 functioning as the information terminal, the spectral measuring section 10, and the external display section 18.

In the information system in the fourth embodiment, as shown in FIG. 12, the disposition of the spectral measuring section 10 on the inside of the smartphone 1 is omitted. Instead, the spectral measuring section 10 is independently provided on the outside of the smartphone 1 as the spectral camera. The operation of the spectral measuring section 10 can be controlled by the smartphone 1. Further, the information system in the fourth embodiment includes, besides the display section 15 included in the smartphone 1, the external display section 18 independently provided on the outside of the smartphone 1. The operation of the external display section 18 can be controlled by the smartphone 1.

The control of the spectral measuring section 10 by the smartphone 1 by electric coupling of the smartphone 1 and the spectral measuring section 10 and the control of the external display section 18 by the smartphone 1 by electric coupling of the smartphone 1 and the external display section 18 may be performed by either wire or radio.

In the information system in the fourth embodiment having such a configuration, acquisition of an image including the measurement target X by the spectral measuring section 10, confirmation by an operator of an image on the external display section 18, and operation such as setting of conditions for specifying the measurement target X by the smartphone 1 can be independently carried out. Therefore, it is possible to improve operability of the information system.

The information system according to the present disclosure can be used by installing an application in the smartphone 1 and coupling the spectral measuring section 10 and the external display section 18 to the smartphone 1. The information system is excellent in versatility because the smartphone 1 not including the spectral measuring section 10 can be used.

Further, by configuring the information system according to the present disclosure to be completed by the smartphone 1, the spectral measuring section 10, and the external display section 18, offline use of the information system is possible for communication other than communication among the smartphone 1, the spectral measuring section 10, and the external display section 18. Therefore, the information system can be used in a place where a communication state is unstable.

Examples of the external display section 18 include a mobile notebook PC, a tablet terminal, a head-up display (HUD), a head-mounted display (HMD). Above all, the external display section 18 is desirably the head-mounted display. With the head-mounted display, for example, a specified result of the measurement target X and a position where the measurement target X is assumed to be present can be displayed in augmented reality (AR). Further, since hand-free use of the head-mounted display is possible, it is possible to further improve operability of the information system.

The same effects as the effects in the first embodiment can be obtained by the information system in the fourth embodiment.

In this embodiment, the information system according to the present disclosure includes the smartphone 1 functioning as the information terminal, the spectral measuring section 10 functioning as the spectral camera, and the external display section 18 such as the head-mounted display. However, the information system according to the present disclosure may include, instead of the smartphone 1, a tablet terminal as the information terminal or may include a server instead of the smartphone 1, that is, the information terminal.

In this embodiment, as shown in FIG. 12, the information system according to the present disclosure independently includes the spectral measuring section 10 and the external display section 18 as separate bodies. However, not only this, but the spectral measuring section 10 and the external display section 18 may be integrally formed.

### Fifth Embodiment

A fifth embodiment of the information system according to the present disclosure is explained.

FIG. 13 is a block diagram showing a schematic configuration of a smartphone and a server applied with the fifth embodiment of the information system according to the present disclosure.

In the following explanation, concerning an information system in the fifth embodiment, differences from the information system in the first embodiment are mainly explained. Explanation of similarities to the information system in the first embodiment is omitted.

The information system in the fifth embodiment shown in FIG. 13 is the same as the information system in the first embodiment except that the information system in the fifth embodiment independently includes a server 100 besides the smartphone 1 functioning as the information terminal. That is, in the information system in the fifth embodiment, the information system according to the present disclosure is not completed by the smartphone 1 alone, which is the information terminal, and includes the smartphone 1 functioning as the information terminal and the server 100.

In the information system in the fifth embodiment, as shown in FIG. 13, the smartphone 1 further includes a transmitting and receiving section 19 and includes, in the control section 60, a transmission and reception control section 606 that controls the operation of the transmitting and receiving section 19.

The server 100 includes a storing section 117, a transmitting and receiving section 119, and a control section 160. The control section 160 includes a data acquiring section 161 and a transmission and reception control section 162 that respectively control the operations of the storing section 117 and the transmitting and receiving section 119.

In the information system in this embodiment, storage of a database for specifying the measurement target X is omitted in the storing section 17 included in the smartphone 1. Instead, the database is stored in the storing section 117 included in the server 100.

The transmitting and receiving section 19 included in the smartphone 1 and the transmitting and receiving section 119 included in the server 100 exchange the database. That is, the transmitting and receiving section 19 transmits a request for acquisition of the database from the storing section 117 to the transmitting and receiving section 119 and receives the database from the server 100 via the transmitting and receiving section 119. The transmitting and receiving section 119 receives the request for acquisition of the database from the storing section 117 by the transmitting and receiving section 19 and transmits the database to the smartphone 1 via the transmitting and receiving section 19. The exchange of the database between the transmitting and receiving section 19 and the transmitting and receiving section 119 may be carried out by either wire or radio. In the case of radio, the exchange of the database may be carried out through the Internet.

The transmission and reception control section 606 included in the control section 60 of the smartphone 1 controls the operation of the transmitting and receiving section 19 and receives the database from the server 100 via the transmitting and receiving section 119. The analysis processing section 604 receives the database from the transmission and reception control section 606 and specifies the measurement target X based on the database.

Further, the data acquiring section 161 included in the control section 160 of the server 100 acquires, in response to the acquisition request, the database stored in the storing section 117 and thereafter passes the database to the transmission and reception control section 162. The transmission and reception control section 162 controls the operation of the transmitting and receiving section 119 and passes the database from the server 100 to the smartphone 1 via the transmitting and receiving section 19.

In the information system in the fifth embodiment having such a configuration, the information system is not completed by the smartphone 1 alone, which is the information terminal, and further includes the server 100. The database is stored in the storing section 117 included in the server 100. The database is transmitted to the smartphone 1 via the transmitting and receiving sections 19 and 119 when the measurement target X is specified. Consequently, there is an advantage that it is unnecessary to cause the storing section 17 included in the smartphone 1 to store a large amount of data. When the information system includes a plurality of smartphones 1, it is possible to share the database. Further, as a result of simply updating the database included in the storing section 117 of the server 100, the database used in the smartphones 1 can be updated to the latest database.

Further, in the information system according to the present disclosure, when the measurement target X is specified by the smartphone 1 during offline, a database necessary during offline only has to be stored in the storing section 17 included in the smartphone 1 from the storing section 117 included in the server 100. Consequently, the measurement target X can be specified by the smartphone 1 even during offline.

The same effects as the effects in the first embodiment can be obtained by the information system in the fifth embodiment.

In this embodiment, the information system according to the present disclosure includes the smartphone 1 functioning as the information terminal and the server 100. However, in the information system according to the present disclosure, instead of the smartphone 1, the information terminal may be configured by a tablet terminal or the like or the smartphone 1, that is, the information terminal may be configured by a digital camera, a digital video camera, a head-up display (HUD), a head-mounted display (HMD), or the like.

Further, in this embodiment, as in the first embodiment, the control section 60 included in the smartphone 1 includes the light-source control section 601, the spectral control section 602, the spectral-image acquiring section 603, the analysis processing section 604, and the display control section 605. However, at least one of these sections may be included in the control section 160 included in the server 100.

### Sixth Embodiment

A sixth embodiment of the information system according to the present disclosure is explained.

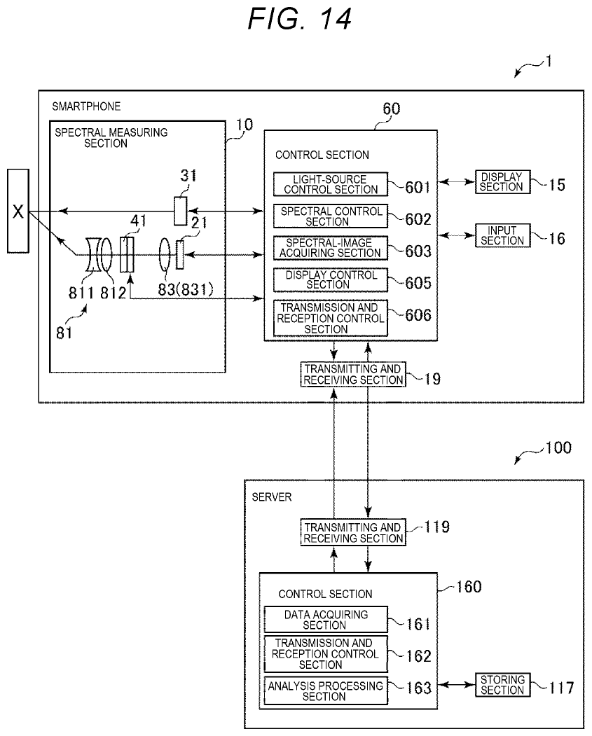

FIG. 14 is a block diagram showing a schematic configuration of a smartphone and a server applied with the sixth embodiment of the information system according to the present disclosure.

In the following explanation, concerning an information system in the sixth embodiment, differences from the information system in the first embodiment are mainly explained. Explanation of similarities to the information system in the first embodiment is omitted.

The information system in the sixth embodiment shown in FIG. 14 is the same as the information system in the first embodiment except that the information system in the sixth embodiment independently includes a server 100 besides the smartphone 1 functioning as the information terminal. That is, in the information system in the sixth embodiment, the information system according to the present disclosure is not completed by the smartphone 1 alone, which is the information terminal, and includes the smartphone 1 functioning as the information terminal and the server 100.

In the information system in the sixth embodiment, as shown in FIG. 14, the smartphone 1 does not include a storing section and an analysis processing section in the control section 60. On the other hand, the smartphone 1 further includes the transmitting and receiving section 19 and includes, in the control section 60, the transmission and reception control section 606 that controls the operation of the transmitting and receiving section 19.

The server 100 includes the storing section 117, the transmitting and receiving section 119, and the control section 160. The control section 160 includes the data acquiring section 161 and the transmission and reception control section 162 that respectively control the operations of the storing section 117 and the transmitting and receiving section 119 and an analysis processing section 163 that specifies the measurement target X.

In the information system in this embodiment, disposition of a storing section in the smartphone 1 is omitted. Instead, the server 100 includes the storing section 117. Like the storing section 17 included in the smartphone 1 in the first embodiment, various data are stored in the storing section 117.

Disposition of an analysis processing section in the control section 60 included in the smartphone 1 is omitted. Instead, the control section 160 included in the server 100 includes the analysis processing section 163. Like the analysis processing section 604 included in the smartphone 1 in the first embodiment, the analysis processing section 163 compares a spectral spectrum, that is, spectral information of the measurement target X and a database to specify the measurement target X.

The transmitting and receiving section 19 included in the smartphone 1 and the transmitting and receiving section 119 included in the server 100 exchange various data. Specifically, for example, the transmitting and receiving section 19 transmits spectral information, that is, a spectral spectrum of the measurement target X acquired by the smartphone 1 to the transmitting and receiving section 119 and receives a specified result of the measurement target X from the server 100 via the transmitting and receiving section 119. The transmitting and receiving section 119 receives, from the smartphone 1, via the transmitting and receiving section 19, the spectral information, that is, the spectral spectrum of the measurement target X acquired by the smartphone 1 and transmits a specified result of the measurement target X to the smartphone 1 via the transmitting and receiving section 19. The exchange of the various data between the transmitting and receiving section 19 and the transmitting and receiving section 119 may be carried out by either wire or radio. In the case of radio, the exchange of the database may be carried out through the Internet.

The transmission and reception control section 606 included in the control section 60 of the smartphone 1 controls the operation of the transmitting and receiving section 19 and transmits the spectral spectrum, that is, the spectral information of the measurement target X acquired by the spectral-image acquiring section 603 to the analysis processing section 163 included in the server 100 via the transmitting and receiving section 119. The analysis processing section 163 acquires the database stored in the storing section 117 by controlling the operation of the data acquiring section 161 and thereafter compares the spectral information and the database to specify the measurement target X.

Further, the transmission and reception control section 162 included in the control section 160 of the server 100 controls the operation of the transmitting and receiving section 119 and passes a specified result of the measurement target X by the analysis processing section 163 from the server 100 to the smartphone 1 via the transmitting and receiving section 19.

In the information system in the sixth embodiment having such a configuration, the information system is not completed by the smartphone 1 alone, which is the information terminal, and further includes the server 100. The database is stored in the storing section 117 included in the server 100. The analysis processing section 163 included in the server 100 specifies the measurement target X based on the database. Thereafter, a specified result of the measurement target X is transmitted to the smartphone 1 via the transmitting and receiving sections 19 and 119. Consequently, there is an advantage that it is unnecessary to cause the storing section included in the smartphone 1 to store a large amount of data and it is unnecessary to apply a large calculation load to the smartphone 1. The measurement target X can be specified more highly accurately by improving a processing ability of the analysis processing section 163 and storing more detailed information of the database in the storing section 117.

When the information system includes a plurality of smartphones 1, it is possible to share the database. Further, as a result of simply updating the database included in the storing section 117 of the server 100, the database used in the smartphones 1 can be updated to the latest database.

The same effects as the effects in the first embodiment can be obtained by the information system in the sixth embodiment.

In this embodiment, the information system according to the present disclosure includes the smartphone 1 functioning as the information terminal and the server 100. However, in the information system according to the present disclosure, instead of the smartphone 1, the information terminal may be configured by a tablet terminal or the like or the smartphone 1, that is, the information terminal may be configured by a digital camera, a digital video camera, a head-up display (HUD), a head-mounted display (HMD), or the like.

Further, in this embodiment, as in the first embodiment, the control section 60 included in the smartphone 1 includes the light-source control section 601, the spectral control section 602, the spectral-image acquiring section 603, and the display control section 605. However, at least one of these sections may be included in the control section 160 included in the server 100.

The information system and the specifying method according to the present disclosure are explained above based on the embodiments shown in the figures. However, the present disclosure is not limited to the embodiments.

For example, in the information system according to the present disclosure, the components can be replaced with components that can exert the same functions. Any components can be added.

In the information system according to the present disclosure, any two or more components explained in the first to sixth embodiments may be combined.

In the specifying method according to the present disclosure, any steps may be added.

What is claimed is:

1. An information system comprising:
an input section to which conditions for acquiring spectral information of a target that should be measured are input;
a spectral measuring section configured to acquire the spectral information of the target;
a storing section in which a database including a plurality of kinds of spectral information is stored;
an analysis processing section configured to specify the target by comparing the spectral information of the target and the database stored in advance; and
a display section configured to display information concerning the specified target.

2. The information system according to claim 1, wherein the information system specifies a kind of the target and displays, on the display section, at least one of an image, the kind, and detailed explanation of the specified target.

3. The information system according to claim 1, wherein the information system specifies presence or absence of the target, presence of which is desired to be specified, and a position where the target is present in an imaging region imaged by the spectral measuring section and displays, on the display section, specified content in the imaging region.

4. The information system according to claim 1, wherein the information system specifies genuineness of the target and displays, on the display section, whether the target is a genuine product.

5. The information system according to claim 1, wherein the information system specifies a degree of deterioration of the target and displays the degree of the deterioration of the target on the display section.

6. The information system according to claim 1, wherein
the information system is completed by an information terminal alone, and
the information terminal includes the input section, the spectral measuring section, the storing section, the analysis processing section, and the display section.

7. The information system according to claim 1, wherein
the information system includes an information terminal and a spectral camera,
the information terminal includes the input section, the storing section, the analysis processing section, and the display section, and
the spectral camera includes the spectral measuring section.

8. The information system according to claim 1, wherein the information system includes an information terminal including the input section, the spectral measuring section, the storing section, the analysis processing section, and the display section and an external display section provided independently from the information terminal.

9. The information system according to claim 8, wherein the external display section is a head-mounted display.

10. The information system according to claim 1, wherein
the information system includes an information terminal and a server,
the information terminal includes the input section, the spectral measuring section, the analysis processing section, and the display section, and
the server includes the storing section.

11. The information system according to claim 1, wherein
the information system includes an information terminal and a server,
the information terminal includes the input section, the spectral measuring section, and the display section, and
the server includes the storing section and the analysis processing section.

12. A specifying method comprising acquiring spectral information of a target that should be measured and thereafter comparing the spectral information of the target and a database prepared in advance to specify the target.

13. A method that is performed by one or more processors comprising:
accepting, via an input interface, a condition for acquiring spectral information of a target to be measured;
acquiring, from a sensor, the spectral information of the target;
specifying the target by comparing the spectral information of the target and a database stored in a memory; and
displaying information concerning the specified target.

14. A non-transitory computer readable medium that stores instructions that cause one or more processors to perform a method comprising:
accepting, via an input interface, a condition for acquiring spectral information of a target to be measured;
acquiring, from a sensor, the spectral information of the target;
specifying the target by comparing the spectral information of the target and a database stored in a memory; and
displaying information concerning the specified target.
